(19) United States
(12) Patent Application Publication
(10) Pub. No.: US 2021/0227202 A1
(43) Pub. Date: Jul. 22, 2021

(54) SWITCHABLE NAKED-EYE FULL-PARALLAX STEREOSCOPIC DISPLAY DEVICE AND DISPLAY METHOD THEREOF

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Yiying PU, Shenzhen, Guangdong (CN); Shensian SYU, Shenzhen, Guangdong (CN)

(21) Appl. No.: 16/099,446

(22) PCT Filed: Aug. 28, 2018
(86) PCT No.: PCT/CN2018/102781

§ 371 Date: Nov. 7, 2018

(30) Foreign Application Priority Data
Jul. 4, 2018 (CN) 201810723574.X

(51) Int. Cl. H04N 13/359; H04N 13/32; H04N 13/324; H04N 13/398; H04N 13/361

(52) U.S. Cl. CPC H04N 13/359; H04N 13/32; H04N 13/361; H04N 13/398; H04N 13/324

(57) ABSTRACT

A switchable naked-eye full-parallax stereoscopic display device and a display method are provided. In the naked-eye stereoscopic display device, a light source module is connected to a chief processor, a light emission controlling module is disposed on the light source module and is connected to the chief processor, and an image displaying module is disposed on the light emission controlling module and is connected to the chief processor. With cooperation of the light source module and the light emission controlling module, 3D display, 360 degree visible, and 2D/3D switchable are achieved.

### BACKGROUND

### 1. Field of the Disclosure

The present invention relates to display technologies, and more particularly, to a switchable naked-eye full-parallax stereoscopic display device and a display method thereof.

### 2. Description of Related Art

Stereoscopy is currently a remarkable and cutting-edge technology. An electronic sand architecture characterized by full parallax, multiple viewing angles, and allowing many people to observe simultaneously, is a particular form of stereoscopic display. This architecture is applicable to military, advertising, and medical applications, allowing observers to have a feeling of perception of an actual scene. Nowadays, three types of ways to achieve a full-parallax display effect primarily are: stereoscopy, holography, and high-density integrated imaging.

The stereoscopy uses some devices to excite matters in a certain space to emit light rays or utilizes mechanical rotation to give a 3D perception with help of human eyes persistence of vision effect. It is a real 3D display approach. It is so realistic in 3D perception. However, its corresponding device system is large and complicated. The holography is also a real 3D display approach. It uses holography materials to record actual waveforms emitted by 3D objects. However, its filming conditions are severe and it is restricted to 3D still images. Although digital holography can carry out 3D dynamic images, it requires a spatial modulator with ultra high resolution. For now, current apparatuses cannot satisfy the digital holography to carry out high-quality 3D dynamic displaying.

The integrated imaging uses a micro lens array to record a scene and recreate the scene. The 3D images recreated using the integrated imaging approach includes full color and continuous parallax information. The observes have a feeling of perception of an actual scene. Also, this approach is characterized by ultra thin and free viewing angles.

Generally, existing 3D integrated display devices need a lens array placed in the front of the display screen for modulating different parallax images and projecting the images to different directions. However, the lens array for a large-scaled screen is expensive and heavy. Once it is fastened in the front of a 2D display screen, 2D/3D switch is not possible.

### SUMMARY

Embodiments of the present invention provide a switchable naked-eye full-parallax stereoscopic display device and a display method thereof based on local dimming technologies. In the existing 3D integrated display devices, once a lens array is fastened in the front of a 2D screen, 2D/3D switch is not possible. The present invention solves such a technical problem.

The embodiments of the present invention provide a switchable naked-eye full-parallax stereoscopic display device, including:

a chief processor configured to transmit signals to a light source module, a light emission controlling module, and an image displaying module;

the light source module configured to emit light rays according to the signals transmitted by the chief processor, the light source module connecting to the chief processor;

the light emission controlling module configured to further control the light rays emitted by the light source module, according to the signals transmitted by the chief processor, and provide a source of light to the image displaying module, the light emission controlling module disposed on the light source module and connecting to the chief processor; and

the image displaying module configured to display images according to the signals transmitted by the chief processor, the image displaying module disposed on the light emission controlling module and connecting to the chief processor;

wherein the light source module and the light emission controlling module consist of a backlight structure providing the source of light for the image displaying module;

the light source module includes a light adjusting driver and a light bead array connecting to the light adjusting driver; the light emission controlling module includes a second driver and a gray-level display panel body connecting to the second driver; the image displaying module including a first driver and a color display panel body connecting to the first driver;

the chief processor connects to the light adjusting driver, the first driver, and the second driver;

when the naked-eye stereoscopic display device is in a 3D display mode, the color display panel body displays a 3D image consisted of a plurality of assembling sub images, the color display panel body including a plurality of assembling units configured to display the assembling sub images;

the light source module and the light emission controlling module consist of a point light source structure providing the source of light for the image displaying module; the dot light source structure includes transparent regions disposed on the gray-level display panel body and corresponding to the assembling units, the transparent regions are transparent and other regions on the gray-level display panel body are opaque; and

the light rays emitted from the light bead array go through the transparent regions and provide diffracted rays for corresponding assembling units to form parallax in viewing the image;

when the naked-eye stereoscopic display device is in a 2D display module, the light source module and the light emission controlling module consist of a surface light source structure providing the source of light for the image displaying module; and

the color display panel body displays a 2D image; the light bead array presents a first gray image corresponding to the 2D image and the light rays of which are changed in different regions and different brightness; the gray-level display panel body presents a second gray image obtained by controlling and adjusting the light rays of the first gray image.

In the switchable naked-eye full-parallax stereoscopic display device of the present invention, when the naked-eye stereoscopic display device is in the 3D display mode, a region of the gray-level display panel body facing a central position of the assembling unit is the transparent region; the light bead army is all lighted up.

In the switchable naked-eye full-parallax stereoscopic display device of the present invention, when the naked-eye stereoscopic display device is in the 3D display mode, pixels of the assembling sub image is arranged as a N*N matrix, where N is a positive integer.

In the switchable naked-eye full-parallax stereoscopic display device of the present invention, when the naked-eye stereoscopic display device is partially in the 3D display mode, the color display panel body displays a composite image assembled by the 3D image and the 2D image; the color display panel body includes a 3D display region configured to display the 3D image and a 2D display region configured to display the 2D image; the gray-level display panel body includes a transmittance controlling region corresponding to the 3D display region and a second gray adjusting region corresponding to the 2D display region; the light bead array includes a light bead lighting region corresponding to the 3D display region and a first gray adjusting region corresponding to the 2D display region;

the 3D display region displays the 3D image, the 3D display region includes the plurality of the assembling units configured to display the assembling sub images; a region of the transmittance controlling region facing a central region of the assembling unit is a transparent region, the transparent region is transparent and other regions of the transmittance controlling region are opaque; light beads of the light bead lighting region are all lighted up; the light rays of the light bead lighting region go through the transparent region and provide the diffracted rays for corresponding assembling unit; and

the 2D display region displays the 2D image, the first gray adjusting region presents the first gray image corresponding to the 2D image and the light rays of which are changed in different regions and different brightness; the second gray adjusting region presents the second gray image obtained by controlling and adjusting the light rays of the first gray adjusting region.

The embodiments of the present invention further provide a switchable naked-eye full-parallax stereoscopic display device, including:

a chief processor configured to transmit signals to a light source module, a light emission controlling module, and an image displaying module;

the light source module configured to emit light rays according to the signals transmitted by the chief processor, the light source module connecting to the chief processor;

the light emission controlling module configured to further control the light rays emitted by the light source module, according to the signals transmitted by the chief processor, and provide a source of light to the image displaying module, the light emission controlling module disposed on the light source module and connecting to the chief processor; and

the image displaying module configured to display images according to the signals transmitted by the chief processor, the image displaying module disposed on the light emission controlling module and connecting to the chief processor;

wherein the light source module and the light emission controlling module consist of a backlight structure providing the source of light for the image displaying module.

In the switchable naked-eye full-parallax stereoscopic display device of the present invention, the light source module includes a light adjusting driver and a light bead army connecting to the light adjusting driver; the light emission controlling module includes a second driver and a gray-level display panel body connecting to the second driver; the image displaying module including a first driver and a color display panel body connecting to the first driver:

the chief processor connects to the light adjusting driver, the first driver, and the second driver.

In the switchable naked-eye full-parallax stereoscopic display device of the present invention, when the naked-eye stereoscopic display device is in a 3D display mode, the color display panel body displays a 3D image consisted of a plurality of assembling sub images, the color display panel body including a plurality of assembling units configured to display the assembling sub images;

the light source module and the light emission controlling module consist of a point light source structure providing the source of light for the image displaying module; the dot light source structure includes transparent regions disposed on the gray-level display panel body and corresponding to the assembling units, the transparent regions are transparent and other regions on the gray-level display panel body are opaque; and

the light rays emitted from the light bead array go through the transparent regions and provide diffracted rays for corresponding assembling units to form parallax in viewing the image.

In the switchable naked-eye full-parallax stereoscopic display device of the present invention, a region of the gray-level display panel body facing a central position of the assembling unit is the transparent region; the light bead array is all lighted up.

In the naked-eye stereoscopic display device of the present embodiment, pixels of the assembling sub image is arranged as a N*N matrix, where N is a positive integer.

In the switchable naked-eye full-parallax stereoscopic display device of the present invention, when the naked-eye stereoscopic display device is in a 2D display module, the light source module and the light emission controlling module consist of a surface light source structure providing the source of light for the image displaying module; and

the color display panel body displays a 2D image; the light bead array presents a first gray image corresponding to the 2D image and the light rays of which are changed in different regions and different brightness; the gray-level display panel body presents a second gray image obtained by controlling and adjusting the light rays of the first gray image.

In the switchable naked-eye full-parallax stereoscopic display device of the present invention, when the naked-eye stereoscopic display device is partially in the 3D display mode, the color display panel body displays a composite image assembled by the 3D image and the 2D image; the color display panel body includes a 3D display region configured to display the 3D image and a 2D display region configured to display the 2D image; the gray-level display panel body includes a transmittance controlling region corresponding to the 3D display region and a second gray adjusting region corresponding to the 2D display region; the light bead array includes a light bead lighting region corresponding to the 3D display region and a first gray adjusting region corresponding to the 2D display region;

the 3D display region displays the 3D image, the 3D display region includes the plurality of the assembling units configured to display the assembling sub images; a region of the transmittance controlling region facing a central region of the assembling unit is a transparent region, the transparent region is transparent and other regions of the transmittance controlling region are opaque; light beads of the light bead lighting region are all lighted up; the light rays of the light bead lighting region go through the transparent region and provide the diffracted rays for corresponding assembling unit; and

the 2D display region displays the 2D image, the first gray adjusting region presents the first gray image corresponding to the 2D image and the light rays of which are changed in different regions and different brightness; the second gray adjusting region presents the second gray image obtained by controlling and adjusting the light rays of the first gray adjusting region.

The present invention further relates to a display method used for the switchable naked-eye full-parallax stereoscopic display device described above. The display method including:

S100: the chief processor receives a display mode signal and after the display mode signal processed by the chief processor, the chief processor transmits corresponding signals to the light source module, the light emission controlling module, and the image displaying module; and

S200: the light source module emits the light rays according to the signals transmitted by the chief processor, the light emission controlling module further controls the light rays emitted by the light source module, according to the signals transmitted by the chief processor; the image displaying module displays the images according to the signals transmitted by the chief processor.

In the display method of the present invention, the light source module includes a light adjusting driver and a light bead array connecting to the light adjusting driver; the light emission controlling module includes a second driver and a gray-level display panel body connecting to the second driver; the image displaying module including a first driver and a color display panel body connecting to the first driver; the chief processor connects to the light adjusting driver, the first driver, and the second driver;

when the naked-eye stereoscopic display device is in a 3D display mode, the color display panel body includes a plurality of assembling units configured to display assembling sub images, a region of the gray-level display panel body facing a central position of the assembling unit is a transparent region, the method including:

S101: the chief processor receives a 3D display mode signal and after the 3D display mode signal is processed by the chief processor, the chief processor transmits 3D image display signals to the first driver, the second driver, and the light adjusting driver;

S201: based on the 3D image display signals, the first driver drives the color display panel body to display a 3D image; based on the 3D image display signals, the second driver drives the gray-level display panel body to let the transparent region be transparent and other regions be opaque; based on the 3D image display signals, the light adjusting driver drives the light bead array to be all lighted up; and

S301: the light rays of the light bead array go through the transparent regions and provide diffracted rays for corresponding assembling units to form parallax in viewing the image to carry out a 3D effect.

In the display method of the present invention, when the naked-eye stereoscopic display device is in a 2D display mode, the method includes:

S102: the chief processor receives a 2D display mode signal and after the 2D display mode signal is processed by the chief processor, the chief processor transmits 2D image display signals to the first driver, the second driver, and the light adjusting driver;

S202: based on the 2D image display signals, the first driver drives the color display panel body to display a 2D image; based on the 2D image display signals, the light adjusting driver drives the light bead array to present a first gray image corresponding to the 2D image and the light rays of which are changed in different regions and different brightness; based on the 2D image, the second driver drives the gray-level display panel body to present a second gray image obtained by controlling and adjusting the light rays of the first gray image; and

S302: after the light rays of the first gray image are controlled and adjusted via the second gray image, a surface light source is provided to the color display panel body.

In the display method of the present invention, pixels of the assembling sub image is arranged as a N*N matrix, where N is a positive integer.

In the display method of the present invention, when the naked-eye stereoscopic display device is partially in the 3D display mode, the color display panel body displays a composite image assembled by the 3D image and a 2D image; the color display panel body includes a 3D display region configured to display the 3D image and a 2D display region configured to display the 2D image; the gray-level display panel body includes a transmittance controlling region corresponding to the 3D display region and a second gray adjusting region corresponding to the 2D display region; the light bead array includes a light bead lighting region corresponding to the 3D display region and a first gray adjusting region corresponding to the 2D display region; the 3D display region includes the plurality of the assembling units configured to display the assembling sub images, and the transmittance controlling region includes the transparent region facing the central position of the assembling unit;

the method including:

S103: the chief processor receives a partial 3D display mode signal and after the partial 3D display mode signal is processed by the chief processor, the chief processor transmits 2D/3D region signals, the 3D image display signals, and 2D image display signals to the first driver, transmits the 2D/3D region signals and the 2D image display signals to the second driver, and transmits the 2D/3D region signals and the 2D image display signals to the light adjusting driver;

S203: based on the 2D/3D region signals, the 2D image display signals, and the 3D image display signals, the first driver drives the color display panel body to display the 2D image in the 2D display region and display the 3D image in the 3D display region;

based on the 2D/3D region signals and the 2D image display signals, the light adjusting driver drives light beads of the light bead lighting region to be all lighted up and drives the first gray adjusting region to present a first gray image corresponding to the 2D image;

based on the 2D/3D region signals and the 2D image display signals, the second driver drives the transparent regions of the transmittance controlling region to be transparent and drives other regions of the transmittance controlling region to be opaque, and drives the second gray adjusting region to display a second gray image obtained by adjusting the light rays of the first gray adjusting region; and

S303: the light rays of the light bead lighting region go through the transparent regions and provide the diffracted rays for the assembling units corresponding to the 3D display region to form parallax in viewing the image to carry out a 3D effect; after the light rays of the first gray image of the first gray adjusting region are controlled and adjusted via the second gray image of the second gray adjusting region, a surface light source is provided to the 2D display region.

Compared to the existing 3D display devices, in the switchable naked-eye full-parallax stereoscopic display device and display method thereof, when the display device is required to be in the 3D display mode, the light emission controlling module functions as a grating by serving the light source module and the light emission controlling module as the point light source structure. When the assembling units are made to two dimensions, full parallax is achieved in the naked-eye stereoscopic display device of the present invention.

When in the 2D display mode, the light source module and the light emission controlling module serve as the surface light source structure for displaying the 2D images. Above all, 2D/3D switchable are achieved. In the existing 3D integrated display devices, once a lens array is fastened in the front of a 2D screen, 2D/3D switch is not possible. The present invention solves such a technical problem.

In addition, in the 2D display mode, the light source module initially adjusts the light rays and then the light rays are precisely adjusted by the light emission controlling module. The light emission controlling module further adjusts the light rays emitted by the light source module. In the existing LCD display devices adopting local dimming technologies, a halo may appear around a bright region among a large area of dark background. The present invention solves such a technical problem.

### BRIEF DESCRIPTION OF DRAWINGS

To illustrate the technical solutions in the embodiments of the present invention or in the existing skills more clearly, the following briefly introduces the accompanying drawings required for describing the embodiments of the present invention. The accompanying drawings in the following description show some embodiments of the present invention, and a person of ordinary skill in the art may still derive other drawings from these accompanying drawings without creative efforts.

FIG. 1 is a schematic diagram showing an existing LCD display device adopting local dimming technologies, in which a halo appears in a bright region among a large area of dark background.

FIG. 2 is a structural diagram showing a switchable naked-eye full-parallax stereoscopic display device according to an embodiment of the present invention.

FIG. 3 is a structural diagram showing a switchable naked-eye full-parallax stereoscopic display device while in a 3D display mode according to an embodiment of the present invention.

FIG. 4 is a structural diagram showing a switchable naked-eye full-parallax stereoscopic display device while in a 2D display mode according to an embodiment of the present invention.

FIG. 5 is a structural diagram showing a switchable naked-eye full-parallax stereoscopic display device while in a partial 3D display mode according to an embodiment of the present invention.

FIG. 6 is a flowchart of a display method of a naked-eye stereoscopic display device according to an embodiment of the present invention.

FIG. 7 is a flowchart of a display method of a naked-eye stereoscopic display device while in a 3D display mode according to an embodiment of the present invention.

FIG. 8 is a flowchart of a display method of a naked-eye stereoscopic display device while in a 2D display mode according to an embodiment of the present invention.

FIG. 9 is a flowchart of a display method of a naked-eye stereoscopic display device while in a partial 3D display mode according to an embodiment of the present invention.

### DETAILED DESCRIPTION OF PREFERRED EMBODIMENTS

Please refer to the appending drawings, the same components are indicated by the same reference numbers. The following descriptions are based on the exemplary embodiment of the present invention and should not be taken to limit the present invention and other embodiments not described herein.

FIG. 2 is a structural diagram showing a switchable naked-eye full-parallax stereoscopic display device according to an embodiment of the present invention. The switchable naked-eye full-parallax stereoscopic display device of the embodiment of the present invention includes a chief processor (not shown), a light source module 10, a light emission controlling module 20, and an image displaying module 30.

Specifically, the chief processor is configured to transmit signals to the light source module 10, the light emission controlling module 20, and the image displaying module 30.

The light source module 10 is configured to emit light rays according to the signals transmitted by the chief processor. The light source module 10 is connecting to the chief processor. The light emission controlling module 20 is configured to further control the light rays emitted by the light source module 10, according to the signals transmitted by the chief processor, and provide a source of light to the image displaying module 30. The light emission controlling module 20 is disposed on the light source module 10 and is connected to the chief processor.

The image displaying module 30 is configured to display images according to the signals transmitted by the chief processor. The image displaying module 30 is disposed on the light emission controlling module 20 and is connected to the chief processor.

The light source module 10 and the light emission controlling module 20 consists of a backlight structure providing the source of light for the image displaying module 30.

In the present embodiment, the light source module 10 and the light emission controlling module 20 as a whole serve as a backlight structure of the image displaying module 30. When the light source module 10 and the light emission controlling module 20 serve as a point light source structure as a whole, the light emission controlling module 20 plays a role as a grating and emits diffracted rays to the image displaying module 30. The image displaying module 30 displays 3D images and the naked-eye stereoscopic display device of the present embodiment is in a 3D display mode. When the light source module 10 and the light emission controlling module 20 serve as a surface light source structure as a whole, the image displaying module 30 displays 2D images and the naked-eye stereoscopic display device of the present embodiment is in a 2D display mode. In such a way, a switch between 2D and 3D display is achieved.

In addition, by dividing the whole of the light source module 10 and the light emission controlling module 20 into point light source regions and surface light source regions, simultaneously displaying 2D and 3D images using the image displaying module 30 is correspondingly achieved. This corresponds to a partial 3D display mode in the present embodiment.

Further, in the 2D display mode, the light emission controlling module 20 further adjusts the gray level of the light rays emitted by the light source module 10. This prevents the image displaying module 30 from causing a halo around a bright region among a large area of dark background.

In the present embodiment, the function of the light source module 10 is to provide the source of light as well as to roughly adjust the light rays in the 2D display mode in consideration of different regions and different brightness changes. This increases the contrast and saves the electric power. The light emission controlling module 20 functions as the grating in the 3D display mode such that the light rays emitted from the light source module 10 can only go through transparent regions (which are similar to pin hole structures), thereby forming the diffracted rays which are provided to the image displaying module 30. The light emission controlling module 20 precisely control the light rays emitted from the light source module 10 in the 2D display mode. This can avoid a halo in a displayed image and improve the image quality.

Specifically, in the naked-eye stereoscopic display device of the present embodiment, the light source module 10 includes a light adjusting driver (not shown) and a light bead array 11 connecting to the light adjusting driver. The light emission controlling module 20 includes a second driver (not shown) and a gray-level display panel body 21 connecting to the second driver. The image displaying module 30 includes a first driver (not shown) and a color display panel body 31 connecting to the first driver.

The chief processor connects to the light adjusting driver, the first driver, and the second driver.

Both of the gray-level display panel body 21 and the color display panel body 31 are liquid crystal display panel bodies.

In the present embodiment, local dimming is utilized in the light source module 10. By receiving the signals from the chief processor, the light adjusting driver of the light source module 10 drives the light bead array 11 to control corresponding light beads or adjust corresponding light rays. By receiving the signals from the chief processor, the second driver of the light emission controlling module 20 drives the gray-level display panel body 21 to handle corresponding transmittance or adjust the gray level. By receiving the signals from the chief processor, the first driver of the image displaying module 30 drives the color display panel body 31 to display corresponding images. The light adjusting driver, the first driver, and the second driver are driver ICs.

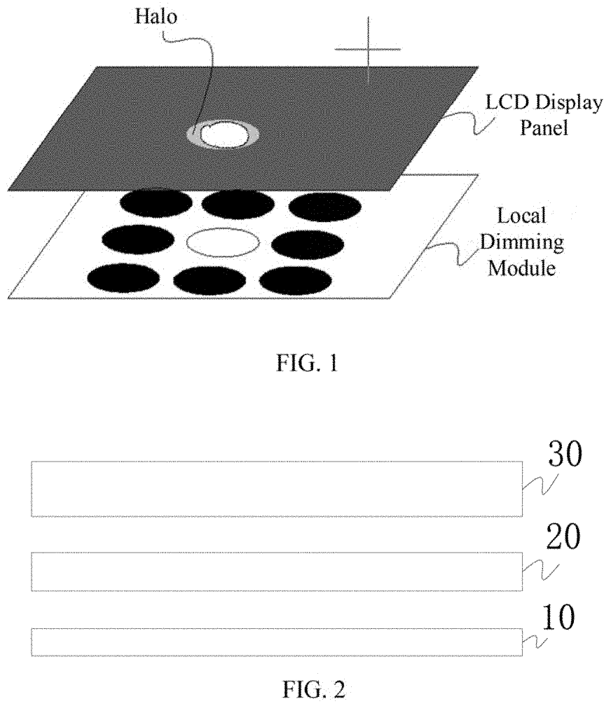

In addition, in displaying the 2D images, the gray-level display panel body 21 of the light emission controlling module 20 presents a gray-level image so as to precisely control the light rays emitted by the light bead array 11. This solves the technical problems in the existing LCD display device adopting local dimming technologies to display a large area of dark background, in which a halo around a bright region appears, as shown in FIG. 1.

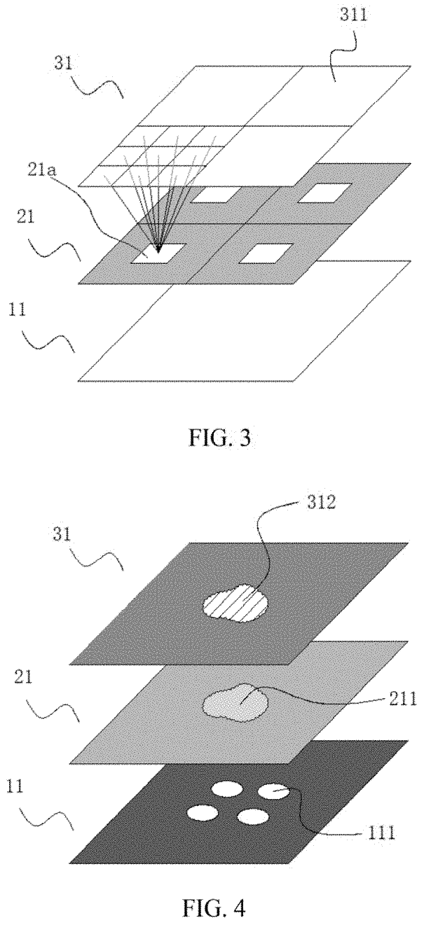

Referring to FIG. 3, in the naked-eye stereoscopic display device of the present embodiment, when the naked-eye stereoscopic display device is in the 3D display mode, the color display panel body 31 displays a 3D image consisted of a plurality of assembling sub images. The color display panel body 31 includes a plurality of assembling units 311 configured to display the assembling sub images. Each assembling unit 311 display an assembling sub image.

The light source module 10 and the light emission controlling module 20 consist of the point light source structure providing the source of light to the image displaying module 30. The point light source structure includes transparent regions disposed on the gray-level display panel body 21 and corresponding to the assembling units 311. The transparent regions are transparent. Other regions on the gray-level display panel body 21 are opaque. The transparent regions are pin hole structures.

The light rays emitted from the light bead array 11 go through the transparent regions 21a and provide diffracted rays for corresponding assembling units 311 to form parallax in viewing the image. In such way, a naked-eye stereoscopic effect is achieved.

Further, a region of the gray-level display panel body 21 facing a central position of the assembling unit 311 is the transparent region 21a. In this region, the light bead array 11 are all lighted up.

The light source module 10 and the light emission controlling module 20 as a whole function as a point light source. The gray-level display panel body 21 plays a role as a grating. At a certain spatial position, the human eye can only see the light rays going through the grating. That is, two eyes can see different images and this forms parallax. This gives a perception of a 3D object. However, when the assembling units 311 are made to one dimension, only one-directional parallax (e.g., horizontal parallax) is achieved in the present embodiment. When the assembling units 311 are made to two dimensions, full parallax is achieved in the present embodiment.

In the naked-eye stereoscopic display device of the present embodiment, pixels of the assembling sub image is arranged as a N*N matrix, where N is a positive integer. This deployment directs to the same viewing angles in horizontal and vertical directions for the displayed images. This avoids differences between the viewing angles and thus improves the quality of 3D images. This prevents the images from visual distortion especially when the images are in rotation states.

Specifically, the followings are illustrated with examples. The color display panel body 31 has four assembling units 311. Accordingly, four assembling sub images consist of a 3D image. Each assembling sub image has nine pixels. The nine pixels are arranged as a 3*3 matrix. Of course, the number of the assembling units 311 and the number of pixels of a assembling sub image depends on actual needs in the present invention. The present invention is not limited thereto.

Referring to FIG. 4, in the naked-eye stereoscopic display device of the present embodiment, when the naked-eye stereoscopic display device is in the 2D display mode, the light source module 10 and the light emission controlling module 20 consist of the surface light source structure providing the source of light to the image displaying module 30. The color display panel body 31 displays a 2D image 312. The light bead array 11 presents a first gray image 111 corresponding to the 2D image and the light rays of which are changed in different regions and different brightness. The gray-level display panel body 21 presents a second gray image 211 obtained by controlling and adjusting the light rays of the first gray image 111.

The light source module 10 roughly adjusts the light rays corresponding to the 2D image in consideration of different regions and different brightness changes. This increases the contrast and saves the electric power. By presenting the second gray image 211, the gray-level display panel body 21 of the light emission controlling module 20 precisely control brightness changes of the first gray image 111 in a further step.

The light rays emitted by the light bead array 11 of the light source module 10 have different luminance. The luminance of the light bead array 11 is adjusted corresponding to the 2D displayed image based on different regions of the 2D displayed image. An image of the luminance presented by the light bead array 11 is the first gray image 111. A gray image presented by the gray-level display panel body 21 corresponding to the 2D displayed image and based on the brightness of the first gray image 111 is the second gray image 211.

Accordingly, the gray-level display panel body 21 makes a precise control to the first gray image 111. This manifests a control and adjustment to the brightness, contrast, and saturation of the first gray image corresponding to the 2D displayed image in different regions with varying degrees.

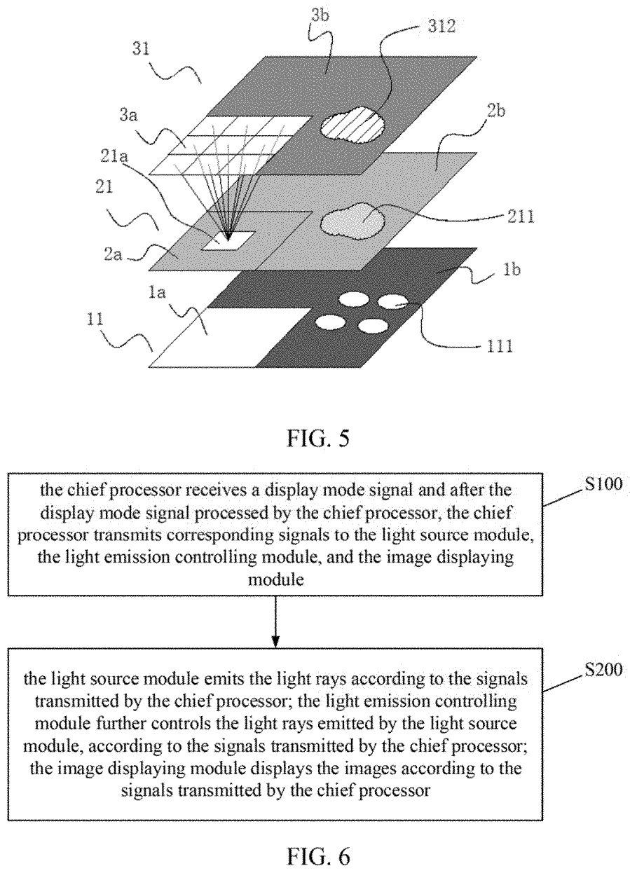

Referring to FIG. 5, in the naked-eye stereoscopic display device of the present embodiment, when the naked-eye stereoscopic display device is in the partial 3D display mode, the color display panel body 31 displays a composite image assembled by the 3D image and the 2D image. The color display panel body 31 includes a 3D display region 3a configured to display the 3D image and a 2D display region 3b configured to display the 2D image. The light bead array 11 includes a light bead lighting region 1a corresponding to the 3D display region 3a and a first gray adjusting region 1b corresponding to the 2D display region 3b. The gray-level display panel body 21 includes a transmittance controlling region 2a corresponding to the 3D display region 3a and a second gray adjusting region 2b corresponding to the 2D display region 3b.

The 3D display region 3a displays the 3D image. The 3D display region includes the plurality of the assembling units 311 configured to display the assembling sub images. A region of the transmittance controlling region 2a facing a central region of the assembling unit 311 is a transparent region 21a. The transparent region 21a is transparent and other regions of the transmittance controlling region 2a are opaque. Light beads of the light bead lighting region 1a are all lighted up. The light rays of the light bead lighting region 1a go through the transparent region 21a and provide the diffracted rays for corresponding assembling unit 311.

The 2D display region 3b displays the 2D image. The first gray adjusting region 1b presents the first gray image corresponding to the 2D image and the light rays of which are changed in different regions and different brightness. The second gray adjusting region 2b presents the second gray image obtained by controlling and adjusting the light rays of the first gray adjusting region 1b.

The partial 3D display mode is a combination of the 3D display mode and the 2D display mode. The principles and structures in the partial 3D display mode are also from a combination of the two modes. The difference between them is that in the partial 3D display mode, the image displaying module 30, the light source module 10, and the light emission controlling module 20 are divided into the 3D display region and the 2D display region.

In addition, in displaying images in the present embodiment, the 3D display region 3a and the 2D display region 3b can be continuously re-divided based on the received 2D/3D region signals.

The present invention further relates to a display method used for the switchable naked-eye full-parallax stereoscopic display device in accordance with above embodiments. Referring to FIG. 6, the display method includes the following steps.

S100: the chief processor receives a display mode signal and after the display mode signal processed by the chief processor, the chief processor transmits corresponding signals to the light source module 10, the light emission controlling module 20, and the image displaying module 30.

S200: the light source module 10 emits the light rays according to the signals transmitted by the chief processor; the light emission controlling module 20 further controls the light rays emitted by the light source module 10, according to the signals transmitted by the chief processor; the image displaying module 20 displays the images according to the signals transmitted by the chief processor.

In Step S100, the display modes include the 3D display mode, the 2D display mode, and the partial 3D display mode. The chief processor obtains different display mode signals and transmits different signals to the light source module 10, the light emission controlling module 20, and the image displaying module 30.

In Step S200, based on different signals and instructions, the light source module 10, the light emission controlling module 20, and the image displaying module 30 do corresponding actions.

Specifically, in the display method of the present embodiment, the light source module 10 includes the light adjusting driver and the light bead array 11 connecting to the light adjusting driver. The light emission controlling module 20 includes the second driver and the gray-level display panel body 21 connecting to the second driver. The image displaying module 30 includes the first driver and the color display panel body 31 connecting to the first driver.

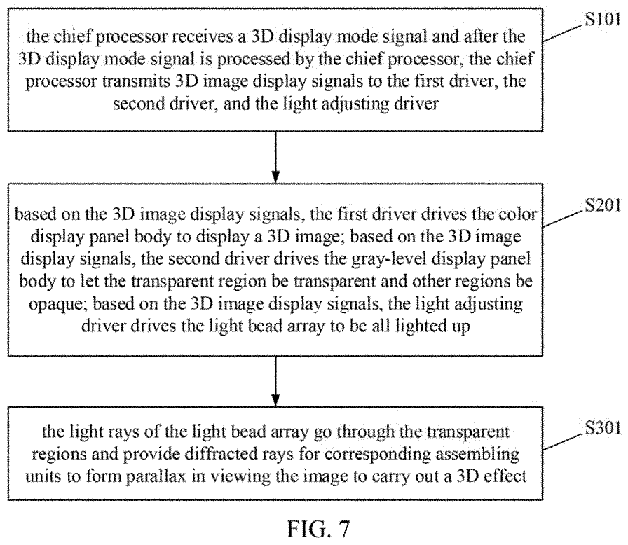

Referring to FIGS. 3 and 7, when the naked-eye stereoscopic display device is in the 3D display mode, the color display panel body includes a plurality of assembling units configured to display assembling sub images. A region of the gray-level display panel body 21 facing a central position of the assembling unit 311 is a transparent region 21a. The method further includes the followings.

S101: the chief processor receives a 3D display mode signal and after the 3D display mode signal is processed by the chief processor, the chief processor transmits 3D image display signals to the first driver, the second driver, and the light adjusting driver.

S201: based on the 3D image display signals, the first driver drives the color display panel body 31 to display a 3D image; based on the 3D image display signals, the second driver drives the transparent region 21a of the gray-level display panel body 21 to let the transparent region be transparent and other regions be opaque; based on the 3D image display signals, the light adjusting driver drives the light bead array 11 to be all lighted up.

S301: the light rays of the light bead array go through the transparent regions and provide diffracted rays for corresponding assembling units to form parallax in viewing the image to carry out a 3D effect.

In the 3D display mode, the light bead array 11 of the light source module 10 are all lighted up. The transparent region of the gray-level display panel body 21 of the light emission controlling module 20 is transparent while other regions are opaque. This makes the light source module 10 and the light emission controlling module 20 as a whole form the point light source structure. Also, the gray-level display panel body 21 acts as a grating. In such a way, parallax is formed and perception of a 3D object is achieved.

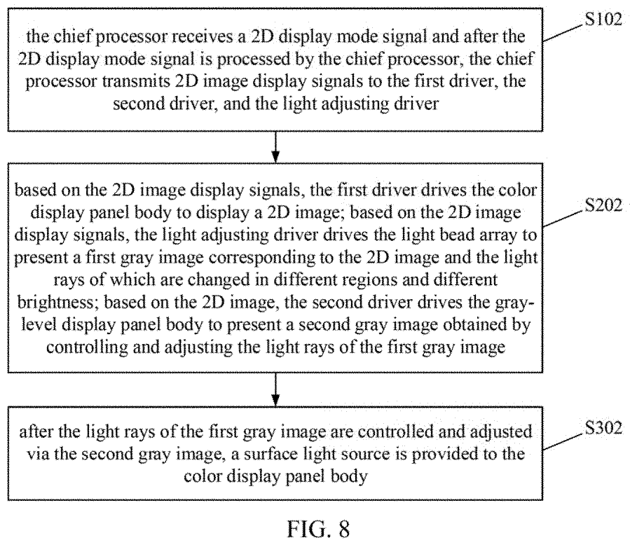

Referring to FIGS. 4 and 8, in the display method, when the naked-eye stereoscopic display device is in the 3D display mode, the method includes the followings.

S102: the chief processor receives a 2D display mode signal and after the 2D display mode signal is processed by the chief processor, the chief processor transmits 2D image display signals to the first driver, the second driver, and the light adjusting driver.

S202: based on the 2D image display signals, the first driver drives the color display panel body 31 to display a 2D image; based on the 2D image display signals, the light adjusting driver drives the light bead array 11 to present a first gray image corresponding to the 2D image and the light rays of which are changed in different regions and different brightness; based on the 2D image, the second driver drives the gray-level display panel body 21 to present a second gray image obtained by controlling and adjusting the light rays of the first gray image.

S302: after the light rays of the first gray image are controlled and adjusted via the second gray image, a surface light source is provided to the color display panel body.

By presenting a gray image, the gray-level display panel body 21 of the light emission controlling module 20 precisely control the light rays emitted by the light bead array 11. This avoids a halo around a bright region in displaying an image with a large area of dark background using the image displaying module 30.

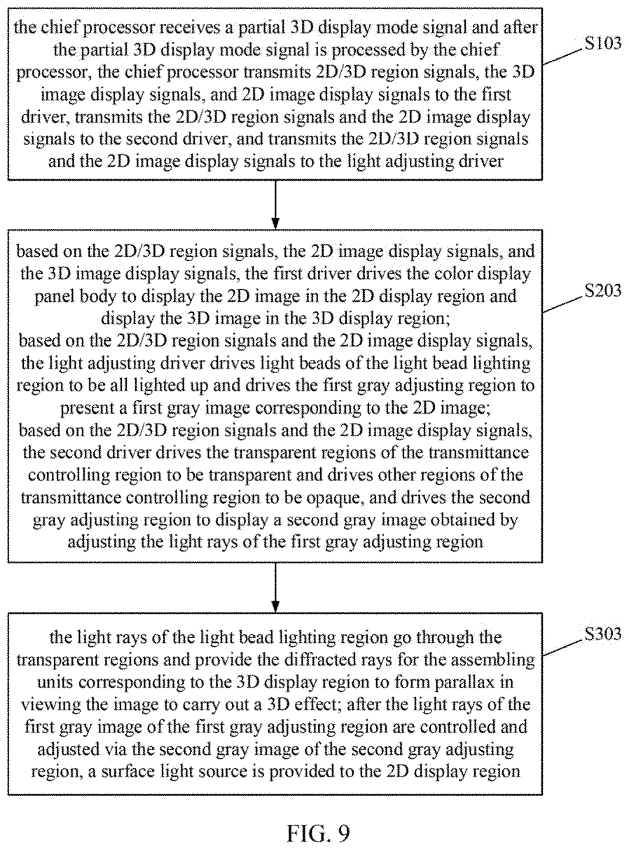

Referring to FIGS. 5 and 9, in the display method, when the naked-eye stereoscopic display device is partially in the 3D display mode, the color display panel body 31 displays a composite image assembled by the 3D image and a 2D image; the color display panel body 31 includes a 3D display region 3a configured to display the 3D image and a 2D display region 3b configured to display the 2D image; the gray-level display panel body 21 includes a transmittance controlling region 2a corresponding to the 3D display region 3a and a second gray adjusting region 2b corresponding to the 2D display region 3b; the light bead array 11 includes a light bead lighting region 1a corresponding to the 3D display region 3a and a first gray adjusting region corresponding to the 2D display region 3b; the 3D display region 3a includes the plurality of the assembling units 311 configured to display the assembling sub images, and the transmittance controlling region 2a includes the transparent region 21a facing the central position of the assembling unit 311.

The display method includes the followings.

S103: the chief processor receives a partial 3D display mode signal and after the partial 3D display mode signal is processed by the chief processor, the chief processor transmits 2D/3D region signals, the 3D image display signals, and 2D image display signals to the first driver, transmits the 2D/3D region signals and the 2D image display signals to the second driver, and transmits the 2D/3D region signals and the 2D image display signals to the light adjusting driver.

S203: based on the 2D/3D region signals, the 2D image display signals, and the 3D image display signals, the first driver drives the color display panel body 31 to display the 2D image in the 2D display region 3b and display the 3D image in the 3D display region 3a;

based on the 2D/3D region signals and the 2D image display signals, the light adjusting driver drives light beads of the light bead lighting region 1a to be all lighted up and drives the first gray adjusting region 1b to present a first gray image 111 corresponding to the 2D image;

based on the 2D/3D region signals and the 2D image display signals, the second driver drives the transparent regions 21a of the transmittance controlling region 2a to be transparent and drives other regions of the transmittance controlling region 2a to be opaque, and drives the second gray adjusting region 2b to display a second gray image 211 obtained by adjusting the light rays of the first gray adjusting region 1b.

S303: the light rays of the light bead lighting region 1a go through the transparent regions 21a and provide the diffracted rays for the assembling units 311 corresponding to the 3D display region 3a to form parallax in viewing the image to carry out a 3D effect; after the light rays of the first gray image 111 of the first gray adjusting region 1b are controlled and adjusted via the second gray image 211 of the second gray adjusting region 2b, a surface light source is provided to the 2D display region.

In the image displaying module 30, the 2D/3D region signals include a 2D region sub signal and a 3D region sub signal. The 2D image display signal outputs the 2D images correspondingly. The 3D image display signals output the 3D images correspondingly. Accordingly, after an integration of the three types of signals, the 2D images are displayed in a region corresponding to the 2D region sub signal and the 3D images are displayed in a region corresponding to the 3D region sub signal. The region corresponding to the 2D region sub signal corresponds to the 2D display region 3b. The region corresponding to the 3D region sub signal corresponds to the 3D display region 3a.

In the light emission controlling module 20, the 2D/3D region signals include the 2D region sub signal and the 3D region sub signal. The 2D image display signal outputs the second gray image 211 correspondingly. Accordingly, after an integration of the two types of signals, the second gray image 211 is presented in a region corresponding to the 2D region sub signal, and a region corresponding to the 3D region sub signal is transparent at middle parts and is opaque at peripheral parts. The region corresponding to the 2D region sub signal corresponds to the second gray adjusting region 2b. The region corresponding to the 3D region sub signal corresponds to the transmittance controlling region 2a.

In the light source module 10, the 2D/3D region signals include the 2D region sub signal and the 3D region sub signal. The 2D image display signal outputs the first gray image 111 correspondingly. Accordingly, after an integration of the two types of signals, the first gray image 111 is presented in a region corresponding to the 2D region sub signal, and the light beads are all lighted up in a region corresponding to the 3D region sub signal. The region corresponding to the 2D region sub signal corresponds to the first gray adjusting region 1b. The region corresponding to the 3D region sub signal corresponds to the light bead lighting region 1a.

In another embodiment of the display method of the present invention, the chief processor receives the three types of signals described above (i.e., the 2D/3D region signals, the 2D image display signals, and the 3D image display signals).

After that, the chief processor processes and does a calculation to the obtained three types of signals to generate a signal relating to the composite image, and transmits the signal to the image displaying module. The image displaying module displays the composite image.

The chief processor processes and does a calculation to the obtained 2D/3D region signals and 2D image display signals to generate a signal relating to the second gray image, and transmits the signal to the light emission controlling module. The light emission controlling module presents the second gray image.

The chief processor processes and does a calculation to the obtained 2D/3D region signals and 2D image display signals to generate a signal relating to the first gray image, and transmits the signal to the light source module. The light source module presents the first gray image.

Compared to the existing 3D display devices, in the switchable naked-eye full-parallax stereoscopic display device and display method thereof, when the display device is required to be in the 3D display mode, the light emission controlling module functions as a grating by serving the light source module and the light emission controlling module as the point light source structure. When the assembling units are made to two dimensions, full parallax is achieved in the naked-eye stereoscopic display device of the present invention.

When in the 2D display mode, the light source module and the light emission controlling module serve as the surface light source structure for displaying the 2D images. Above all, 2D/3D switchable are achieved. In the existing 3D integrated display devices, once a lens array is fastened in the front of a 2D screen, 2D/3D switch is not possible. The present invention solves such a technical problem.

In addition, in the 2D display mode, the light source module initially adjusts the light rays and then the light rays are precisely adjusted by the light emission controlling module. The light emission controlling module further adjusts the light rays emitted by the light source module. In the existing LCD display devices adopting local dimming technologies, a halo may appear around a bright region among a large area of dark background. The present invention solves such a technical problem.

Although one or more embodiment was described in this article, a person skilled in the relevant filed may derive some equivalent variants and modifications based on reading and understanding the specification and drawings. This article should include all kinds of such equivalent variants and modifications, and is only limited in the appended claims. Additionally, although a particular feature of the present disclosure has been made with respect to certain implementations, in which only one is disclosed, but for given or particular applications, this feature may be expected and beneficial in a combination of one or other features of other implementations. Moreover, the terms “include” “with”, or “have” or their variants, where used in a specification or claim, are designed to have a similar meaning to “comprise”.

Above all, while the present invention have been illustrated and described with embodiments in detail, the numbering of the embodiments such as “first” and “second” are merely for convenience in description. The order of various embodiments of the present invention is not limited thereto. Also, it is intended that the present invention should not be limited to the particular forms as illustrated, and that all modifications and alterations which maintain the spirit and realm of the present invention are within the scope as defined in the appended claims.

1. A switchable naked-eye full-parallax stereoscopic display device, comprising:
a chief processor configured to transmit signals to a light source module, a light emission controlling module, and an image displaying module;
the light source module configured to emit light rays according to the signals transmitted by the chief processor, the light source module connecting to the chief processor;
the light emission controlling module configured to further control the light rays emitted by the light source module, according to the signals transmitted by the chief processor, and provide a source of light to the image displaying module, the light emission controlling module disposed on the light source module and connecting to the chief processor; and
the image displaying module configured to display images according to the signals transmitted by the chief processor, the image displaying module disposed on the light emission controlling module and connecting to the chief processor;
wherein the light source module and the light emission controlling module consist of a backlight structure providing the source of light for the image displaying module;
the light source module comprises a light adjusting driver and a light bead array connecting to the light adjusting driver; the light emission controlling module comprises a second driver and a gray-level display panel body connecting to the second driver; the image displaying module comprising a first driver and a color display panel body connecting to the first driver;
the chief processor connects to the light adjusting driver, the first driver, and the second driver;
when the naked-eye stereoscopic display device is in a 3D display mode, the color display panel body displays a 3D image consisted of a plurality of assembling sub images, the color display panel body comprising a plurality of assembling units configured to display the assembling sub images;
the light source module and the light emission controlling module consist of a point light source structure providing the source of light for the image displaying module; the dot light source structure comprises transparent regions disposed on the gray-level display panel body and corresponding to the assembling units, the transparent regions are transparent and other regions on the gray-level display panel body are opaque;
the light rays emitted from the light bead army go through the transparent regions and provide diffracted rays for corresponding assembling units to form parallax in viewing the image;
when the naked-eye stereoscopic display device is in a 2D display module, the light source module and the light emission controlling module consist of a surface light source structure providing the source of light for the image displaying module; and
the color display panel body displays a 2D image; the light bead array presents a first gray image corresponding to the 2D image and the light rays of which are changed in different regions and different brightness; the gray-level display panel body presents a second gray image obtained by controlling and adjusting the light rays of the first gray image.

2. The device according to claim 1, wherein when the naked-eye stereoscopic display device is in the 3D display mode, a region of the gray-level display panel body facing a central position of the assembling unit is the transparent region; the light bead array is all lighted up.

3. The device according to claim 1, wherein when the naked-eye stereoscopic display device is in the 3D display mode, pixels of the assembling sub image is arranged as a N*N matrix, where N is a positive integer.

4. The device according to claim 1, wherein when the naked-eye stereoscopic display device is partially in the 3D display mode, the color display panel body displays a composite image assembled by the 3D image and the 2D image; the color display panel body comprises a 3D display region configured to display the 3D image and a 2D display region configured to display the 2D image; the gray-level display panel body comprises a transmittance controlling region corresponding to the 3D display region and a second gray adjusting region corresponding to the 2D display region; the light bead array comprises a light bead lighting region corresponding to the 3D display region and a first gray adjusting region corresponding to the 2D display region;
the 3D display region displays the 3D image, the 3D display region comprises the plurality of the assembling units configured to display the assembling sub images; a region of the transmittance controlling region facing a central region of the assembling unit is a transparent region, the transparent region is transparent and other regions of the transmittance controlling region are opaque; light beads of the light bead lighting region are all lighted up; the light rays of the light bead lighting region go through the transparent region and provide the diffracted rays for corresponding assembling unit; and
the 2D display region displays the 2D image, the first gray adjusting region presents the first gray image corresponding to the 2D image and the light rays of which are changed in different regions and different brightness; the second gray adjusting region presents the second gray image obtained by controlling and adjusting the light rays of the first gray adjusting region.

5. A switchable naked-eye full-parallax stereoscopic display device, comprising:
a chief processor configured to transmit signals to a light source module, a light emission controlling module, and an image displaying module;
the light source module configured to emit light rays according to the signals transmitted by the chief processor, the light source module connecting to the chief processor;
the light emission controlling module configured to further control the light rays emitted by the light source module, according to the signals transmitted by the chief processor, and providing a source of light to the image displaying module, the light emission controlling module disposed on the light source module and connecting to the chief processor; and
the image displaying module configured to display images according to the signals transmitted by the chief processor, the image displaying module disposed on the light emission controlling module and connecting to the chief processor;
wherein the light source module and the light emission controlling module consist of a backlight structure providing the source of light for the image displaying module.

6. The device according to claim 5, wherein the light source module comprises a light adjusting driver and a light bead array connecting to the light adjusting driver; the light emission controlling module comprises a second driver and a gray-level display panel body connecting to the second driver; the image displaying module comprising a first driver and a color display panel body connecting to the first driver; and
the chief processor connects to the light adjusting driver, the first driver, and the second driver.

7. The device according to claim 6, wherein when the naked-eye stereoscopic display device is in a 3D display mode,
the color display panel body displays a 3D image consisted of a plurality of assembling sub images, the color display panel body comprising a plurality of assembling units configured to display the assembling sub images;
the light source module and the light emission controlling module consist of a point light source structure providing the source of light for the image displaying module; the dot light source structure comprises transparent regions disposed on the gray-level display panel body and corresponding to the assembling units, the transparent regions are transparent and other regions on the gray-level display panel body are opaque; and
the light rays emitted from the light bead array go through the transparent regions and provide diffracted rays for corresponding assembling units to form parallax in viewing the image.

8. The device according to claim 7, wherein a region of the gray-level display panel body facing a central position of the assembling unit is the transparent region; the light bead array is all lighted up.

9. The device according to claim 7, wherein pixels of the assembling sub image is arranged as a N*N matrix, where N is a positive integer.

10. The device according to claim 6, wherein when the naked-eye stereoscopic display device is in a 2D display module, the light source module and the light emission controlling module consist of a surface light source structure providing the source of light for the image displaying module, and
the color display panel body displays a 2D image; the light bead array presents a first gray image corresponding to the 2D image and the light rays of which are changed in different regions and different brightness; the gray-level display panel body presents a second gray image obtained by controlling and adjusting the light rays of the first gray image.

11. The device according to claim 6, wherein when the naked-eye stereoscopic display device is partially in the 3D display mode, the color display panel body displays a composite image assembled by the 3D image and the 2D image; the color display panel body comprises a 3D display region configured to display the 3D image and a 2D display region configured to display the 2D image; the gray-level display panel body comprises a transmittance controlling region corresponding to the 3D display region and a second gray adjusting region corresponding to the 2D display region; the light bead array comprises a light bead lighting region corresponding to the 3D display region and a first gray adjusting region corresponding to the 2D display region;
the 3D display region displays the 3D image, the 3D display region comprises the plurality of the assembling units configured to display the assembling sub images; a region of the transmittance controlling region facing a central region of the assembling unit is a transparent region, the transparent region is transparent and other regions of the transmittance controlling region are opaque; light beads of the light bead lighting region are all lighted up; the light rays of the light bead lighting region go through the transparent region and provide the diffracted rays for corresponding assembling unit; and
the 2D display region displays the 2D image, the first gray adjusting region presents the first gray image corresponding to the 2D image and the light rays of which are changed in different regions and different brightness; the second gray adjusting region presents the second gray image obtained by controlling and adjusting the light rays of the first gray adjusting region.

12. A display method used for the switchable naked-eye full-parallax stereoscopic display device of claim 5, the method comprising:
S100: the chief processor receives a display mode signal and after the display mode signal processed by the chief processor, the chief processor transmits corresponding signals to the light source module, the light emission controlling module, and the image displaying module; and
S200: the light source module emits the light rays according to the signals transmitted by the chief processor, the light emission controlling module further controls the light rays emitted by the light source module, according to the signals transmitted by the chief processor; the image displaying module displays the images according to the signals transmitted by the chief processor.

13. The method according to claim 12, wherein the light source module comprises a light adjusting driver and a light bead array connecting to the light adjusting driver; the light emission controlling module comprises a second driver and a gray-level display panel body connecting to the second driver; the image displaying module comprising a first driver and a color display panel body connecting to the first driver, the chief processor connects to the light adjusting driver, the first driver, and the second driver;
when the naked-eye stereoscopic display device is in a 3D display mode, the color display panel body comprises a plurality of assembling units configured to display assembling sub images, a region of the gray-level display panel body facing a central position of the assembling unit is a transparent region, the method comprising:
S111: the chief processor receives a 3D display mode signal and after the 3D display mode signal is processed by the chief processor, the chief processor transmits 3D image display signals to the first driver, the second driver, and the light adjusting driver;
S201: based on the 3D image display signals, the first driver drives the color display panel body to display a 3D image; based on the 3D image display signals, the second driver drives the gray-level display panel body to let the transparent region be transparent and other regions be opaque; based on the 3D image display signals, the light adjusting driver drives the light bead array to be all lighted up; and
S301: the light rays of the light bead array go through the transparent regions and provide diffracted rays for corresponding assembling units to form parallax in viewing the image to carry out a 3D effect.

14. The method according to claim 13, wherein when the naked-eye stereoscopic display device is in a 2D display mode, the method comprises:
S102: the chief processor receives a 2D display mode signal and after the 2D display mode signal is processed by the chief processor, the chief processor transmits 2D image display signals to the first driver, the second driver, and the light adjusting driver;
S202: based on the 2D image display signals, the first driver drives the color display panel body to display a 2D image; based on the 2D image display signals, the light adjusting driver drives the light bead array to present a first gray image corresponding to the 2D image and the light rays of which are changed in different regions and different brightness; based on the 2D image, the second driver drives the gray-level display panel body to present a second gray image obtained by controlling and adjusting the light rays of the first gray image; and
S302: after the light rays of the first gray image are controlled and adjusted via the second gray image, a surface light source is provided to the color display panel body.

15. The method according to claim 13, wherein pixels of the assembling sub image is arranged as a N*N matrix, where N is a positive integer.

16. The method according to claim 13, wherein when the naked-eye stereoscopic display device is partially in the 3D display mode, the color display panel body displays a composite image assembled by the 3D image and a 2D image; the color display panel body comprises a 3D display region configured to display the 3D image and a 2D display region configured to display the 2D image; the gray-level display panel body comprises a transmittance controlling region corresponding to the 3D display region and a second gray adjusting region corresponding to the 2D display region; the light bead array comprises a light bead lighting region corresponding to the 3D display region and a first gray adjusting region corresponding to the 2D display region; the 3D display region comprises the plurality of the assembling units configured to display the assembling sub images, and the transmittance controlling region comprises the transparent region facing the central position of the assembling unit; the method comprising:
S103: the chief processor receives a partial 3D display mode signal and after the partial 3D display mode signal is processed by the chief processor, the chief processor transmits 2D/3D region signals, the 3D image display signals, and 2D image display signals to the first driver, transmits the 2D/3D region signals and the 2D image display signals to the second driver, and transmits the 2D/3D region signals and the 2D image display signals to the light adjusting driver;
S203: based on the 2D/3D region signals, the 2D image display signals, and the 3D image display signals, the first driver drives the color display panel body to display the 2D image in the 2D display region and display the 3D image in the 3D display region;
based on the 2D/3D region signals and the 2D image display signals, the light adjusting driver drives light beads of the light bead lighting region to be all lighted up and drives the first gray adjusting region to present a first gray image corresponding to the 2D image;
based on the 2D/3D region signals and the 2D image display signals, the second driver drives the transparent regions of the transmittance controlling region to be transparent and drives other regions of the transmittance controlling region to be opaque, and drives the second gray adjusting region to display a second gray image obtained by adjusting the light rays of the first gray adjusting region; and
S303: the light rays of the light bead lighting region go through the transparent regions and provide the diffracted rays for the assembling units corresponding to the 3D display region to form parallax in viewing the image to carry out a 3D effect; after the light rays of the first gray image of the first gray adjusting region are controlled and adjusted via the second gray image of the second gray adjusting region, a surface light source is provided to the 2D display region.
